(19) United States
(12) Patent Application Publication
(10) Pub. No.: US 2024/0400444 A1
(43) Pub. Date: Dec. 5, 2024

(54) Workable Self-Adhering Cementitious Composition

(71) Applicant: Dale Keith Haggerty, Edmonton (CA)

(72) Inventor: Dale Keith Haggerty, Edmonton (CA)

(21) Appl. No.: 18/327,319

(22) Filed: Jun. 1, 2023

(51) Int. Cl. C04B 7/02; C04B 14/06; C04B 24/24; C04B 28/04

(52) U.S. Cl. CPC C04B 7/02; C04B 14/06; C04B 24/24; C04B 28/04; C04B 2111/275; C04B 2111/72

(57) ABSTRACT

A workable self-adhering cementitious composition and method of making and using such a composition. The cementitious composition includes a mixture of portland cement, sand, and an adhesive. The composition forms a workable plaster, with or without added water, that is spreadable over a variety of surfaces, such as interior and exterior walls, roofs, floors, siding, and the like. The composition allows users to spread or stucco over most surfaces regardless of the exterior finish of that surface. Moreover, after a layer of the cementitious composition has cured, it can bond with a second layer, thereby allowing for multiple coats to be applied to any surface.

### BACKGROUND OF THE INVENTION

The present invention relates to a workable self-adhering cementitious composition and method of using such a composition. The self-adhering cementitious composition includes a mixture of portland cement, sand, and an adhesive. The composition forms a workable plaster that is spreadable over a variety of surfaces, such as interior and exterior walls, roofs, floors, siding, and the like. In some embodiments, the mixture has water added therewith. The composition allows users to spread or stucco over most surfaces regardless of the exterior finish of that surface. Additionally, after a layer of the cementitious composition has cured, it bonds to itself allowing for multiple coats to be applied.

Polychlorinated biphenyls (PCBs) were commercially manufactured in the United States from about 1930 until 1979, when their production was banned under the Toxic Substances Control Act (TSCA) because of concerns about their extreme environmental persistence, ability to bioaccumulate, and adverse human health effects. PCBs were used in numerous industrial and consumer applications. Most notably as caulking, floor mastic, paint, and in fluorescent light ballasts.

Although the epidemiological evidence is sometimes conflicting, most health agencies have concluded that PCBs may reasonably be a carcinogen, i.e., to cause cancer. The ongoing presence of PCBs can create risks for building owners and material manufacturers. To mitigate those risks, it is important to identify, remove, and properly dispose of building materials containing PCBs. When renovating and remodeling older buildings, workers are required to evaluate the building for the presence of PCBs and mitigate the risk of spreading the PCBs into the surrounding environment. Moreover, older paints and other residential and industrial applications utilized lead and asbestos in many forms. Like PCBs, when the lead and asbestos become disturbed it causes adverse human health effects.

A common technique for removing material from a surface is sandblasting, sometimes known as abrasive blasting, is the operation of forcibly propelling a stream of abrasive material against a surface under high pressure to smooth a rough surface, roughen a smooth surface, or remove surface contaminants. This is a common technique, however, in older buildings, the presences of PCBs, lead, and the like creates a risk that these harmful particles are released into the air. Therefore, there exists a need for a system that prevents the spreading of the toxic material while recoating an older surface.

Existing concrete mixtures can be found in commercial retailers in bags that require water to be added to hydrate and cure. One such product, dryvit® Primus® is an acrylic-modified product. However, this known product does not bond well to many surfaces, such as wood, and other similar products that require specific additives.

In light of the devices disclosed in the known art, it is submitted that the present invention substantially diverges in design elements and methods from the known art and consequently it is clear that there is a need in the art for an improvement for a self-adhering cementitious composition. In this regard the instant invention substantially fulfills these needs.

### SUMMARY OF THE INVENTION

In view of the foregoing disadvantages inherent in the known types of cementitious composition now present in the known art, the present invention provides a new self-adhering cementitious composition wherein the same can be utilized for resurfacing an exterior wall containing PCBs and providing a plaster for adhering brick to an exterior wall.

It is an objective of the present invention to provide self-adhering cementitious composition that is easily mixed and adherable to a variety of surfaces.

It is another objective of the present invention to provide a self-adhering cementitious composition comprising a dry mixture of 1-part cement and 2-3 parts sand; at least 1 cup of glue adhesive per 50 pounds of dry mixture; wherein the dry mixture is mixed with the glue adhesive to form the workable cementitious composition; wherein the composition is adapted for application directly to a variety of surfaces for mechanical adhesion, the surfaces comprising Styrofoam, acrylic, paint, limestone, wood, glass, and steel; and wherein the composition is adapted to self-adhere with a cured surface of the workable cementitious composition.

It is another objective of the present invention to provide a self-adhering cementitious composition that bonds to itself after a cure time, wherein multiple layers/coats may be applied over a given period.

It is another objective of the present invention to provide a self-adhering cementitious composition that is used over surfaces containing hazardous material to prevent the undesirable spread into the environment.

It is yet another objective of the present invention to provide a self-adhering cementitious composition that prevents the spreading of the toxic material recoating an older surface by not requiring the removal or blasting of the older surface.

It is therefore an object of the present invention to provide a new and improved self-adhering cementitious composition that has all of the advantages of the known art and none of the disadvantages.

Other objects, features, and advantages of the present invention will become apparent from the following detailed description taken in conjunction with the accompanying drawings.

### DETAILED DESCRIPTION OF THE INVENTION

For the purposes of presenting a brief and clear description of the present invention, the preferred embodiment will be discussed as used for resurfacing an exterior wall containing PCBs and providing a plaster for adhering brick to an exterior wall.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment”, “first embodiment”, “second embodiment”, or “third embodiment” does not necessarily refer to the same embodiment.

The workable cementitious composition provides a self-adhering cementitious composition includes a mixture of portland cement, sand, and an adhesive. The composition forms a workable plaster that is spreadable over a variety of surfaces, such as interior and exterior walls, roofs, floors, siding, and the like. In one embodiment, the workable cementitious composition comprises a dry mixture of 1-part cement and 2-3 parts sand and at least 1 cup of glue adhesive per 50 pounds of dry mixture. In one embodiment, the dry mixture is mixed with the glue adhesive to form the workable cementitious composition. The glue adhesive consists of water that allows for the hydration of the cement. In another embodiment, the dry mixture is mixed with the glue adhesive and water to form the workable cementitious composition. In some embodiments, the water content of glue ranges between 20% to 80% by weight.

In one embodiment, the composition allows users to spread or stucco over most surfaces regardless of the exterior finish of that surface. Additionally, after a first layer of the cementitious composition has cured, a second layer can be applied and then bond to the first layer allowing for multiple coats to be applied. In some embodiments, the layer of cementitious composition cures within 30 minutes. The rate of curing depends on several factors, including the water content of the mixture. Other factors include the exposure to light, humidity, and the like.

In one embodiment, the cementitious composition is mixed in a 5-gallon container for immediate usage. The composition comprises 2-3 parts sand, 1-2 parts cement, and between 1 cup to approximately 4 cups of glue adhesive. In yet another embodiment, the cementitious composition is mixed in a 9 cubic foot cement mixer having maximum 6 cubic foot batch volume. The batch volume is the maximum effective capacity of the mixer. In this embodiment, 80 kilogram of fine sand, 80 kilograms of portland cement, and half a gallon of glue are added to the cement mixer. In one embodiment, the glue adhesive is a dry mixture of powdered glue. In such an embodiment, water is added to the glue in an additional step.

In one embodiment, a workable cementitious composition for application to a surface consists of: a dry mixture of 1-part cement and 2-3 parts sand; at least 1 cup of glue adhesive per 50 pounds of dry mixture.

In one embodiment, a workable cementitious composition for application to a surface essentially consists of: a dry mixture of 1-part cement and 2-3 parts sand; at least 1 cup of glue adhesive per 50 pounds of dry mixture. The workable cementitious composition is also adapted for application directly to a variety of surfaces for mechanical adhesion, the surfaces comprising Styrofoam, acrylic, paint, limestone, wood, glass, and steel, and wherein the composition is adapted to self-adhere with a cured surface of the workable cementitious composition.

A workable cementitious composition consisting of a dry mixture of 1-part cement and 2-3 parts sand; at least 1 cup water per 50 pounds of dry mixture; at least 1 cup of glue adhesive per 50 pounds of dry mixture; wherein the dry mixture is mixed with the glue adhesive to form the workable cementitious composition; wherein the composition is adapted for application directly to a variety of surfaces for mechanical adhesion, the surfaces comprising Styrofoam, acrylic, paint, limestone, wood, glass, and steel; and wherein the composition is adapted to self-adhere with a cured surface of the workable cementitious composition.

In one exemplary application, a large batch of the cementitious composition is mixed in the cement mixer. The composition is applied to an exterior wall via a trowel, similar to conventional mortar. The consistency of the composition is thick enough to adhere to the vertical surface to form a layer and workable to allow for spreading thereacross. The layer can be formed having a thickness of between 0.25 inches and 4 inches. In alternative embodiments, the layer exceeds 4 inches of thickness. In yet other embodiments, the layer is applied and allowed to cure. After the curing, another layer of the cementitious composition is applied over the base layer. Since the cementitious composition is self-adhering, the second layer bonds with the base layer. Since the cementitious composition adheres to a wide variety of surfaces, it can also be applied directly over hazardous material such as PCBs, asbestos, and lead, thus preventing the removal of the older coatings prior to recoating with a cement containing product.

A method of recoating an existing coated surface with a workable cementitious composition, comprising providing the workable cementitious composition. The workable cementitious composition comprises a dry mixture of 1-part cement and 2-3 parts sand, at least 1 cup of glue adhesive per 50 pounds of dry mixture, and wherein the dry mixture is mixed with the glue adhesive to form the workable cementitious composition. The composition is adapted for application directly to a variety of surfaces for mechanical adhesion, the surfaces comprising Styrofoam, acrylic, paint, limestone, wood, glass, and steel. Moreover, the composition is adapted to self-adhere with a cured surface of the workable cementitious composition. The method includes applying a first layer directly over the existing coated surface, curing the first layer by allowing a period of time not less than 30 minutes, and adhering a second layer directly over the first layer once it has cured.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A workable cementitious composition for application to a surface, comprising:
a dry mixture of 1-part cement and 2-3 parts sand;
at least 1 cup of glue adhesive per 50 pounds of dry mixture;
wherein the dry mixture is mixed with the glue adhesive to form the workable cementitious composition;
wherein the composition is adapted for application directly to a variety of surfaces for mechanical adhesion, the surfaces comprising Styrofoam, acrylic, paint, limestone, wood, glass, and steel;
wherein the composition is adapted to self-adhere with a cured surface of the workable cementitious composition.

2. The workable cementitious composition of claim 1, wherein the cement is portland cement.

3. The workable cementitious composition of claim 1, wherein the glue adhesive is liquid.

4. The workable cementitious composition of claim 1, wherein the glue adhesive is powder.

5. The workable cementitious composition of claim 1, wherein the sand is finely divided stone having a particle size of between 50 mesh and 200 mesh.

6. The workable cementitious composition of claim 1, further comprising between 1-2 parts fiber selected from the group consisting of: steel, carbon, polypropylene, polyester, basalt rock, fiberglass, and glass.

7. The workable cementitious composition of claim 1, wherein the composition is waterproof.

8. The workable cementitious composition of claim 1, further comprising between 1-2 parts insulation selected from the group consisting of: cork, textiles, mineral wool, and fiber.

9. The workable cementitious composition of claim 1, wherein water is added to the dry mixture.

10. The workable cementitious composition of claim 9, wherein the water added to the dry mixture includes at least 1 cup water per 50 pounds of dry mixture.

11. A workable cementitious composition consisting of:
a dry mixture of 1-part cement and 2-3 parts sand;
at least 1 cup water per 50 pounds of dry mixture;
at least 1 cup of glue adhesive per 50 pounds of dry mixture; wherein the dry mixture is mixed with the glue adhesive to form the workable cementitious composition;
wherein the composition is adapted for application directly to a variety of surfaces for mechanical adhesion, the surfaces comprising Styrofoam, acrylic, paint, limestone, wood, glass, and steel;
wherein the composition is adapted to self-adhere with a cured surface of the workable cementitious composition.

12. A method of recoating an existing coated surface with a workable cementitious composition, comprising:
providing the workable cementitious composition, comprising:
a dry mixture of 1-part cement and 2-3 parts sand;
at least 1 cup of glue adhesive per 50 pounds of dry mixture;
wherein the dry mixture is mixed with the glue adhesive to form the workable cementitious composition;
wherein the composition is adapted for application directly to a variety of surfaces for mechanical adhesion, the surfaces comprising Styrofoam, acrylic, paint, limestone, wood, glass, and steel;
wherein the composition is adapted to self-adhere with a cured surface of the workable cementitious composition;
applying a first layer directly over the existing coated surface;
curing the first layer by allowing a period of time not less than 30 minutes;
adhering a second layer directly over the first layer once it has cured.

13. The method of recoating an existing coated surface of claim 12, wherein the existing surface is wood.

14. The method of recoating an existing coated surface of claim 12, wherein the existing surface contains unremoved PBCs.
